(19) United States
(12) Patent Application Publication
(10) Pub. No.: US 2007/0137604 A1
(43) Pub. Date: Jun. 21, 2007

(54) Motorcycle engine

(76) Inventors: John R. Silseth, Edina, MN (US); Alwyn Melling, Rochdale (GB)

Correspondence Address: SCHWEGMAN, LUNDBERG, WOESSNER & KLUTH, P.A., P.O. BOX 2938, MINNEAPOLIS, MN, 55402, US

(21) Appl. No.: 11/314,604

(22) Filed: Dec. 21, 2005

(51) Int. Cl. F02F 1/42; F02N 3/00; F02B 27/02; F01N 7/00

(52) U.S. Cl. 123/193.5; 60/314; 60/324; 123/188.3

(57) ABSTRACT

A motorcycle engine is described which reduces heat transfer to cylinder heads of the engine. Embodiments provide for cylinder head exhaust port to reduce exhaust flame contact. A valve guide to provide additional support due to the modified cylinder head is described. Controlling exhaust flame paths by controlling an exhaust valve angle is described. An intake manifold and engine piston are described for improved engine performance.

### FIELD OF THE INVENTION

The present invention relates to internal combustion engines and, more particularly, to engines for use in a motorcycle.

### BACKGROUND

In the early 1900's motorcycle manufactures, such as Harley Davidson, introduced motorcycles having a V-twin two cylinder engine. Although it has changed and has significant performance issues, over the last century the v-twin has remained the primary engine design for motorcycles.

One V-twin design currently used is a 45-degree V-twin. This engine has serious built-in design defects when considered for high performance. Further, motorcycles have traditionally been exempt from government regulated emission standards. This exemption will be changed in the future.

The main problems with current V-twin engines are cylinder head temperature. The engine head temperature is a related to the fact that the V-twin engine is air cooled and tends to have large cylinder volumes. The cylinder head temperature has serious affects on both emission performance and engine power performance. The cylinder head temperature should be kept at a designed temperature when the engine is running hard, and the cylinder head temperature must be controlled during normal running to meet emission regulations throughout the world. For high power output on this type of engine the compression ratio must be as high as possible, the amount of compression ratio used at the present time is limited by the heat generated in the cylinder head.

It is know that engines require a high level of compression ratio to meet stringent emission regulations. Increasing the compression ratio and engine temperature, however, of the V-twin type of engine is not currently feasible.

### SUMMARY

In one embodiment, a V-twin motorcycle engine comprises an exhaust valve having a stem, and a cylinder head comprising an exhaust port extending between an exhaust valve seat and an exhaust flange. The exhaust valve extends through the exhaust valve seat and a top surface of the exhaust port. The top surface of the exhaust port is shaped to prevent contact between an exhaust flame passing through the exhaust port from the exhaust valve seat to an exhaust flange. The exhaust flame passes through the exhaust valve seat at a location substantially limited to one side of the exhaust valve stem.

In another embodiment a V-twin engine valve guide comprises a stem section having a center opening sized to accommodate an exhaust valve stem there through, and a cup located at an upper end of the stem section. An outside of the cup is configured to fit within a valve spring seat of a cylinder head and an inside of the cup is sized to accommodate a valve spring therein.

A method of modifying a V-twin motorcycle engine is provided. The method includes removing material from a cylinder head of the engine. The material is located at a top portion of an exhaust port of the cylinder head, and the volume of material removed allows an exhaust flame to pass through the exhaust port without substantially contacting a top surface of the exhaust port or substantially transferring heat to the cylinder head. A valve guide is installed into the cylinder head. The valve guide comprising a stem section having a center opening sized to accommodate an exhaust valve stem there through, and a cup located at an upper end of the stem section. An outside of the cup is configured to fit within a valve spring seat of the cylinder head and an inside of the cup is sized to accommodate a valve spring therein.

In yet another embodiment, a method of modifying a V-twin motorcycle engine is provided. The motorcycle engine includes an exhaust valve located within a cylinder head at a first location such that during operation an exhaust flame from a cylinder flows past the exhaust valve on substantially one side of the exhaust valve. The method includes changing the first location of the exhaust valve to a second location such that the exhaust flame flows substantially uniformly around the exhaust valve to reduce localized heating of the cylinder head during operation.

### BRIEF DESCRIPTION OF THE DRAWINGS

FIG. 1 is a side view of a prior art cylinder head of a V-twin engine;

FIG. 2 is a cross-section of a prior art cylinder head of FIG. I showing an exhaust port;

FIG. 3 is a cross-section of a cylinder head on an embodiment of the present invention with a modified exhaust port;

FIG. 4 illustrates a cross-section of a valve guide of an embodiment of the invention;

FIG. 5 illustrates an exhaust valve location of an embodiment of the present invention relative to a prior art exhaust valve location;

FIG. 6 is a perspective view of cylinder heads and an intake manifold of an embodiment of the present invention;

FIG. 7 is a bottom perspective view of a piston of an embodiment of the present invention; and

FIG. 8 is a side perspective view of the piston of FIG. 7.

### DESCRIPTION

In the following detailed description of the invention, reference is made to the accompanying drawings which form a part hereof, and in which is shown, by way of illustration, different embodiments in which the invention may be practiced. These embodiments are described in sufficient detail to enable those skilled in the art to practice the invention. Other embodiments may be utilized and structural, logical, and electrical changes may be made without departing from the scope of the present invention.

Applicants performed extensive testing of 45-degree V-twin engines to determine how engine temperatures can be better controlled to allow for higher compression ratios. Specifically, the internal ‘burn’ was monitored using cameras placed inside of an engine to track the internal combustion operation. Flame and heat patterns were studied to identify where and how to improve the V-twin engine by reducing cylinder head operating temperatures of the engine.

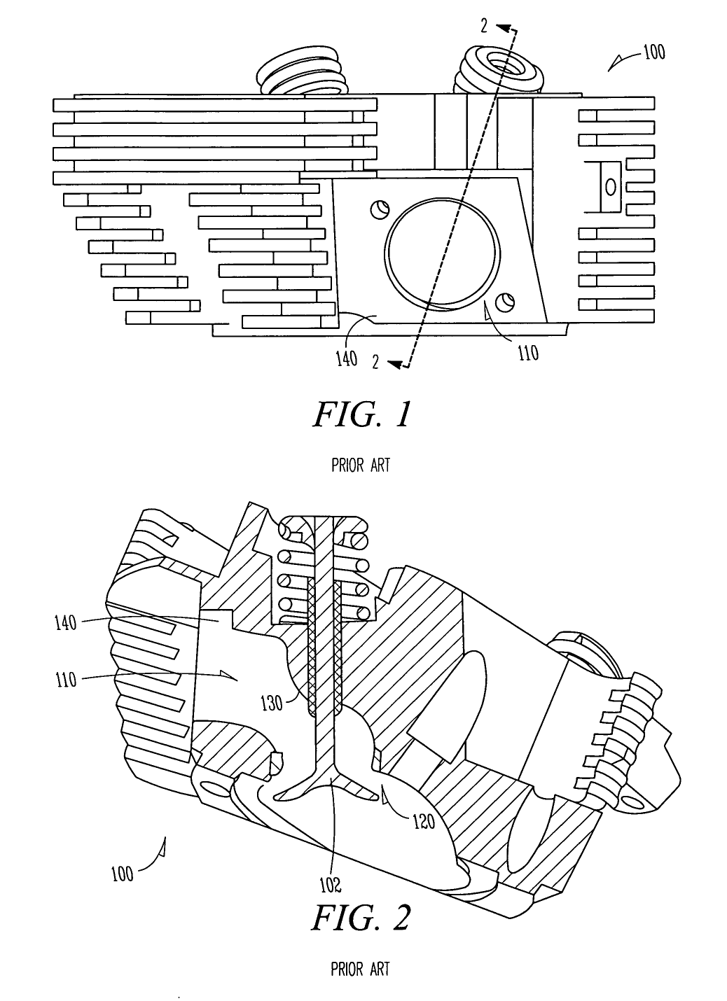

It was noted that during the experimentation one primary reason for the high cylinder head temperature was that the internal exhaust flame only existed over the top of the exhaust valve. FIG. 1 is a perspective view of a cylinder head and FIG. 2 illustrates a cross-section view of the prior art engine cylinder head 100 at exhaust port 110 and valve 102 where the exhaust flame is illustrated by arrow 120. These flames burn the ceiling 130 of the exhaust port causing extreme heat to be absorbed by the cylinder head. The existing prior art exhaust port shape is shown in FIG. 2, the shape is derived from the need to have a port from the exhaust valve 102 to the point of an exhaust flange 140.

It was recognized that the exhaust flange 140 needs to remain constant such that a user of the engine can replace the engine exhaust systems (not shown) without modification. As such, the position of the prior art exhaust valve 102 and the position of the exhaust flange 140 should remain unchanged.

Embodiments of the invention teach that the prior art exhaust port of the V-twin engine can be modified to allow the flame to have more ceiling in one embodiment of the present invention. Modifying the exhaust port as described herein allows more expansion of the combustion gases in the exhaust port area, which in turn reduces the overhaul cylinder head temperature. On a test engine incorporating a modified exhaust port as taught below, the cylinder head temperature was reduced by 30 degrees over a complete running cycle from idle speed to wide open throttle. The engine did suffer exhaust valve guide ware, however, due to very little support in the cylinder head for the valve guide. Embodiments of the invention provide a valve guide to address this problem.

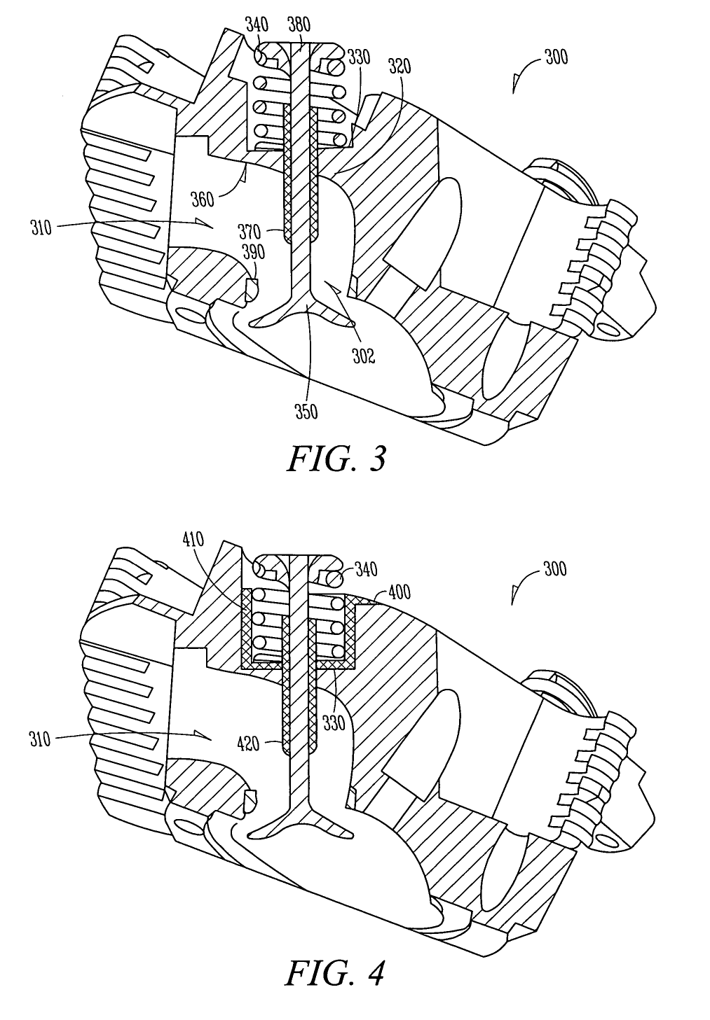

Referring to FIG. 3, a cylinder head 300 includes a modified exhaust port 310. The exhaust port is modified from the prior art to reduce surface area contacted by the exhaust flame after exiting the exhaust valve seat location 390. The present invention is not limited to a specific exhaust port volume or shape, but provides for reducing the cylinder head material in the exhaust port that could be contacted by the exhaust fame. In one embodiment the exhaust valve guide support material is substantially reduced at area 320 between a top surface 360 of the exhaust port 310 and a valve spring seat location 330 for a spring 340 of exhaust valve 350. In one example embodiment, a Harley Davidson V-twin engine having a wall thickness between the valve spring seat and the top of the exhaust port 360 is about 25 to 28 mm is modified with the inventive exhaust porting to be about 6 to 7 mm. Reducing the wall thickness of the cylinder head in the exhaust port may be viewed as counterintuitive as a means for reducing heat transfer from the exhaust port. That is, more material is typically viewed as the preferred means for avoiding localized heating by conducting the heat away from the region.

As illustrated in FIG. 3, a prior art valve guide 370 is located around a stem 380 of the exhaust valve 350 in an embodiment of the invention where the exhaust port has been modified as explained above. The reduced wall thickness of the cylinder head between the exhaust port and the valve spring does not provide sufficient support for the valve guide. That is, the prior art valve guide can twist and experience excessive wear with the modified exhaust port of an embodiment of the invention.

To address the above problem with supporting the exhaust valve, embodiments of the invention provide a valve guide. As illustrated in FIG. 4, the guide is supported above the valve spring seat location in addition to the normal valve stem support. The valve guide includes an upper ‘cup’ 410 that fits within the valve spring seat 330 and is sized to allow the valve spring 340 to be located within the valve guide. A stem section 420 includes a center opening sized to accommodate the exhaust valve stem there through. This allows the exhaust port 310 to have less exhaust flame restriction and provides the needed support to the valve guide.

The above modifications to a prior art V-twin engine do not change the exhaust valve location or operation. As such, the flame continues to travel in the top region of the exhaust valve. By opening the top of the exhaust port the flames are better controlled to avoid heating the cylinder head. In another embodiment, the exhaust valve location is modified to allow the exhaust flame to more evenly exit the cylinder.

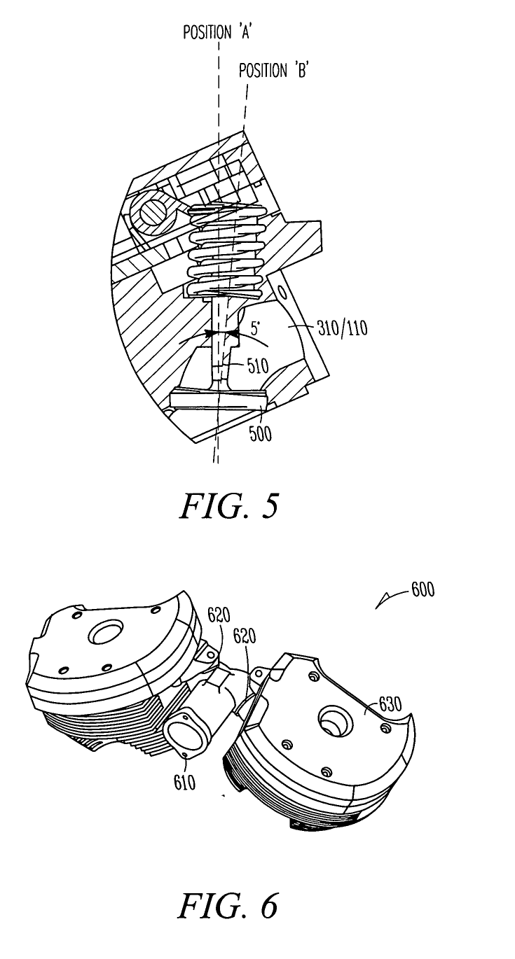

Referring to FIG. 5, a prior art V-twin engine exhaust valve angle is shown as Position A. In an embodiment of the invention the valve stem 510 of valve 500 has an angle which is moved about 5 degrees relative to the prior art, and a relative angle to the piston (not shown), to Position B. In this embodiment, the exhaust flame tends to travel equally between the top of the valve and the bottom of the valve. The roof of the port, therefore, is only contacted by part of the flame. The exhaust port 310/110 can have a shape as described above with reference to FIGS. 1 or 3. In tests with this embodiment, the exhaust gas temperature transferred to the cylinder head was reduced by 35% while using a prior art port shape of FIG. 1. Further, the existing exhaust system can still be used because the new exhaust valve angle has no effect on the exhaust flange position. As such, an embodiment of the invention provides for modifying a V-twin engine exhaust valve angle to balance an exit location of exhaust flames around an exhaust valve.

With the above embodiments, the exhaust flame can exit directly out of the exhaust port leading to better exhaust emissions and lower cylinder head temperatures. A higher compression ratio can be used which also decreases exhaust emissions.

A prior art 45 degree V-twin cylinder engine of a typically U.S.A.-type motorcycle engine has cylinder head inlet ports located on the right hand side of the motorcycle when viewed from the front of the motorcycle. This design can provide a restriction to efficiency and exhaust emissions. That is, the prior art design results in an inlet manifold that is very short this causes a loss of harmonics in the inlet tract. As a result, the engine is not able to generate any kind of inlet pressure increase.

In one embodiment of the present invention illustrated in FIG. 6, the cylinder head inlet port flange are arranged on the left of the bike and the carburetor/fuel injector body flange is placed on the right hand side. More specifically, the cylinder head input manifold 600 is designed to channel the fuel from a fuel source location 610 on one side of the engine 630 to cylinder input locations 620 on an opposite side of the engine. In this embodiment, the inlet tract is effectively twice as long allowing for harmonics and pressure effects in the inlet tracts.

Prior art V-twin engines often suffer from bad crankshaft balance which results in limited R.P.M. In addition, customers desire large engine displacements. Taking into account the desire for cylinder capacities to be as big as possible, engine designers must design current V-twin engines with a long stroke. The engine with a long stroke increases the piston speed and with the extra cylinder capacity the piston now becomes very susceptible to failure. Engine designers try to make the piston as light weight has possible but this only puts the rotating mass more out of balance.

To try and obtain the horsepower required to satisfy the market the designer now has to resort to camshaft profiles that are producing transients that are completely illegal or the manufacturer produces an engine with below par power output.

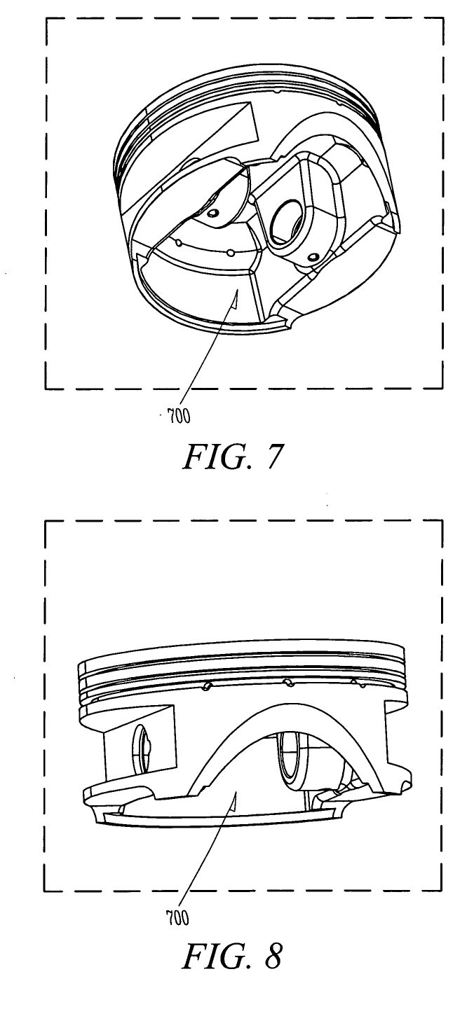

In embodiments of the present invention engines can be fitted with big bore cylinders and short strokes providing the piston is designed carefully. In FIGS. 7-8, a piston 700 is shown that is approx. 4.875 inches in diameter. This piston, at 5000 rpm and a stroke of 4.375 inches, weighs 1.78 Newton's. This can be balanced by the engine's flywheels and the resulting engine produces more power and due to the higher rpm less damaging transients. In addition more piston reliability is experienced due to the lower piston speed. In contrast to the present invention, a commercially available V-twin engine the piston height to diameter ratio is a minimum of 1:1.

1. A V-twin motorcycle engine comprising:
an exhaust valve having a stem; and
a cylinder head comprising an exhaust port extending between an exhaust valve seat and an exhaust flange, wherein the exhaust valve extends through the exhaust valve seat and a top surface of the exhaust port, the top surface of the exhaust port is shaped to prevent contact between an exhaust flame passing through the exhaust port from the exhaust valve seat to an exhaust flange, wherein the exhaust flame passes through the exhaust valve seat at a location substantially limited to one side of the exhaust valve stem.

2. The engine of claim 1 further comprising a valve guide comprising:
a stem section having a center opening sized to accommodate the exhaust valve stem there through, and
a cup located at an upper end of the stem section, wherein an outside of the cup is configured to fit within a valve spring seat of the cylinder head and an inside of the cup is sized to accommodate a valve spring therein.

3. The engine of claim 1 wherein the cylinder head includes an inlet port flange, and further comprises an intake manifold coupled to the inlet port, the intake manifold comprises a fuel source input location wherein the fuel source input location is on an opposite side of the cylinder head from the inlet port flange.

4. A V-twin engine valve guide comprising:
a stem section having a center opening sized to accommodate an exhaust valve stem there through; and
a cup located at an upper end of the stem section, wherein an outside of the cup is configured to fit within a valve spring seat of a cylinder head and an inside of the cup is sized to accommodate a valve spring therein.

5. A method of modifying a V-twin motorcycle engine comprising:
removing material from a cylinder head of the engine, the material being located at a top portion of an exhaust port of the cylinder head, wherein the volume of material removed allows an exhaust flame to pass through the exhaust port without substantially contacting a top surface of the exhaust port or substantially transferring heat to the cylinder head; and
installing a valve guide into the cylinder head, the valve guide comprising a stem section having a center opening sized to accommodate an exhaust valve stem there through, and a cup located at an upper end of the stem section, wherein an outside of the cup is configured to fit within a valve spring seat of the cylinder head and an inside of the cup is sized to accommodate a valve spring therein.

6. The method of claim 5 further comprising locating a camera within the engine to identify a path of the exhaust flame through the exhaust port prior to removing the material.

7. The method of claim 5 further comprising increasing a cylinder bore of the engine and reducing a piston stroke length of the engine.

8. A method of modifying a V-twin motorcycle engine, wherein the motorcycle engine comprises an exhaust valve located within a cylinder head at a first location such that during operation an exhaust flame from a cylinder flows past the exhaust valve on substantially one side of the exhaust valve, the method comprising:
changing the first location of the exhaust valve to a second location such that the exhaust flame flows substantially uniformly around the exhaust valve to reduce localized heating of the cylinder head during operation.

9. The method of claim 8 further comprising increasing a cylinder bore of the engine and reducing a piston stroke length of the engine.

10. The method of claim 8 further comprising:
removing material from the cylinder head of the engine, the material being located at a top portion of an exhaust port of the cylinder head, wherein the volume of material removed allows the exhaust flame to pass through the exhaust port without substantially contacting a top surface of the exhaust port or substantially transferring heat to the cylinder head.

11. The method of claim 10 further comprising:
installing a valve guide into the cylinder head, the valve guide comprising a stem section having a center opening sized to accommodate an exhaust valve stem there through, and a cup located at an upper end of the stem section, wherein an outside of the cup is configured to fit within a valve spring seat of the cylinder head and an inside of the cup is sized to accommodate a valve spring therein.
